(19) United States
(12) Patent Application Publication
(10) Pub. No.: US 2012/0237844 A1
(43) Pub. Date: Sep. 20, 2012

(54) Method for Operating a Fuel Cell System

(75) Inventors: Armin Muetschele, Weilheim (DE); Holger Richter, Kirchheim (DE)

(73) Assignee: Daimler AG, Stuttgart (DE)

(21) Appl. No.: 13/499,439

(22) PCT Filed: Sep. 10, 2010
(86) PCT No.: PCT/EP10/05565

§ 371 Date: May 24, 2012

(30) Foreign Application Priority Data
Sep. 30, 2009 (DE) 102009 043 569.7

(51) Int. Cl. H01M 8/04

(52) U.S. Cl. 429/429

(57) ABSTRACT

A method serves for operating a fuel cell system with at least a fuel cell and a feed air side air conveyor and an outgoing air side turbine. The fuel cell system is flushed at least during a switching-off procedure with air from the air conveyor. During flushing a connection is created between the air conveyor and the outgoing air side between the fuel cell and turbine.

### BACKGROUND AND SUMMARY OF THE INVENTION

The invention relates to a method for operating a fuel cell system.

Fuel cell systems are known from the general prior art. They can be equipped with, for example, an air conveying means and an outgoing air side turbine, as described for example by the German patent DE 102 16 953 B4.

It is now also known that during operation of fuel cells moisture or water is produced as one of the products. It is known from the general prior art in this connection that fuel cell systems can be flushed with air upon switching off in order to correspondingly dry them and thus prevent water freezing at temperatures below freezing point. Such a method is described, for example, in the German publication open to public inspection DE 101 50 386 A1. In addition DE 103 14 820 A1 describes a comparable method as a method for preventing water freezing in a structural unit containing at least a movable part in an anode circuit of a fuel cell system.

A so-called exhaust valve is also known from the patent document DE 102 16 953 B4, via which the outlet of a flow compressor can be connected to the inlet of the turbine directly connected to this flow compressor. By means of this exhaust valve the quantity of air flowing to the fuel cell can be correspondingly adjusted, as an outgoing air path can be created with a low pressure loss, via which a part of the compressed air can be blown out again. This is necessary in order to be able to correspondingly control in the short term the turbocharger described there in the form of a freewheel mechanism, as otherwise the rapid control of the mass flow of the air supply is difficult.

There are essentially two disadvantages in the flushing of a fuel cell system with air as described above. A comparatively large air quantity is necessary in order to ensure that the whole system and in particular the turbine are completely free of liquid droplets so that it is not blocked upon restart of the system by possibly frozen droplets. This must be conveyed through the whole system, which brings with it a high energy requirement for providing the flushing air and unnecessarily greatly dries out the membranes of the fuel cell formed as PEM fuel cell stacks.

Exemplary embodiments of the present invention provide a method for operating a fuel cell system that facilitates a reliable operation and in particular reliable restart at temperatures below freezing point without damaging the fuel cell itself in the longer term and which in addition has an energy requirement which is as low as possible.

In accordance with the present invention, during flushing a connection is created between the air conveying means and the outgoing air side between the fuel cell and turbine. Such a connection can be realized, for example, via a so-called system bypass valve allows at least during part of the time of the flushing process the flushing air—after it has been compressed by the air conveying means—to be conveyed directly or at least bypassing the fuel cell itself into the region of the turbine. A volume flow through the turbine can thus be realized with comparatively low pressure loss and thus low energy use. The turbine is driven and expels any droplets through the centrifugal force. These are then flushed out and/or dried by the air heated in the air conveying means. The turbine thus remains in a completely dry state so that in case of a restart even at temperatures below freezing point it cannot be blocked by condensed and frozen water droplets. It can accordingly start up immediately and fulfill its functionality.

In a particularly favorable and advantageous embodiment of the method according to the invention the flushing takes place directly after disconnection of the fuel cell system. This flushing process corresponds in relation to the timing to the conventional flushing process, as known from the prior art. However, this is realized at least for part of the time via the system bypass valve and thus serves with minimum energy use merely for drying of the turbine. Thus there is conveyance directly into the turbine without having to flow through the fuel cell previously. An excessive drying out of the fuel cell is thus prevented and the energy requirement arising through the pressure loss in the fuel cell is avoided.

According to a very favorable and advantageous further development of the method according to the invention the flushing additionally takes place on occasion during the operation of the fuel cell system. This makes it possible for an occasional flushing of the system or turbine in certain operating phases in the system or after the expiry of a certain time, in particular insofar as a temperature is present below freezing point. It is thus possible during operation or in particular during short standstill phases, for example in a standby operation, which can arise through a start-stop operation of the fuel cell system in a vehicle, that the freezing can also be prevented.

In a particularly favorable and advantageous development of the method according to the invention the air conveying means is driven at least partially through the turbine. This structure can be realized, for example, as a freewheel mechanism, but in particular as a so-called electric turbocharger (ETC=electric turbo charger) allows a part of the energy required to compress the flushing air to be recovered through expansion in the turbine. The turbine supplies this energy then for example additionally to an electric motor drive of the air conveying means to reduce the required electric drive power of the air conveying means.

In a further very favorable and advantageous embodiment of the inventive method this is used to operate a fuel cell system in a transport means, in particular a motor vehicle. The structure allows the fuel cell system to be switched off and operated in such a way that problems cannot arise through temperatures below freezing point in relation to a restart or a re-run of the system. This application can be used in particular in transport means that require comparatively frequent switching off and restart of the fuel cell system and which typically operate frequently in outside areas and thus also at temperatures below freezing point.

### BRIEF DESCRIPTION OF THE DRAWING FIGURES

Further advantageous embodiments of the invention follow from the remaining dependent claims and are clear by reference to the example embodiment which is described in greater detail below by reference to the drawings, in which:

FIG. 1 shows a first possible embodiment of a fuel cell system for use with the inventive method; and

FIG. 2 a second possible embodiment of a fuel cell system for use with the inventive method.

### DETAILED DESCRIPTION

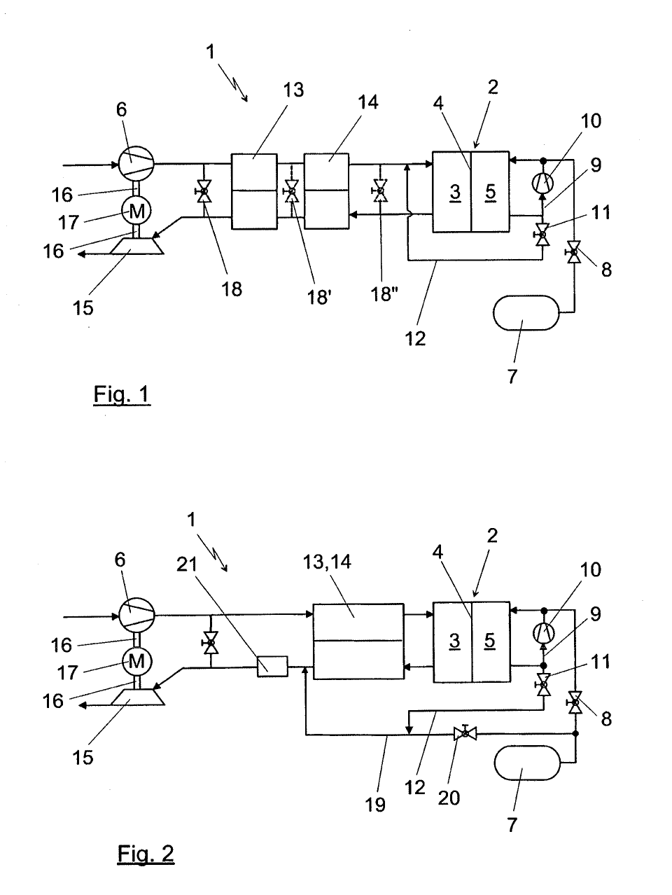

FIG. 1 illustrates a representation of a fuel cell system 1. The core of the fuel cell system 1 is a fuel cell 2 that comprises a cathode chamber 3 separated from an anode chamber 5 by proton exchange membranes 4. The fuel cell 2 is thereby to be designed in a preferred embodiment as a PEM fuel cell stack. The fuel cell 2 or the cathode chamber 3 of the fuel cell 2 is supplied with air via an air conveying means 6, such as a compressor. In the fuel cell 2 the oxygen in this air is converted together with hydrogen from a hydrogen storage means 7 into electric power and product water. This takes place through the membranes 4. The hydrogen from the hydrogen storage means 7 is then dosed via a valve means 8 to the anode chamber 5 of the fuel cell 2. In order to be able to supply the fuel cell 2 in all regions with an adequate quantity of hydrogen, typically more hydrogen is introduced into the anode chamber 5 than can be converted therein. The remaining hydrogen then passes via a recirculation line 9 and a recirculation conveying means 10 back into the region of the inlet of the anode chamber 5. It flows from here together with fresh hydrogen from the hydrogen storage means 7 back into the region of the anode chamber 5. This so-called anode circuit is known from the general prior art. In time nitrogen becomes enriched in this anode circuit or inert gas that diffuses from the cathode chamber 3 through the membranes 4 into the anode chamber 5. In addition, water arises in the region of the recirculation line 9 which is produced in the anode chamber 5. Although this is not such a large quantity of product water as arises in the cathode chamber 3, inert gas and water are, however, enriched in the circuit through the circuit conveyance. The more water and inert gas in the circuit the smaller the concentration of the hydrogen, the performance of the fuel cell 2 suffers over time. A discharge valve 11 is thus provided in order to discharge water and/or inert gas via a discharge line 12. This waste gas from the anode chamber 5 is thereby fed to the feed air, to the cathode chamber 3. As a certain remainder of hydrogen is also always discharged via the discharge valve 11 this can then react on the electro catalysts in the cathode chamber 3 so that it does not reach the environment. This procedure is also known from the general prior art for fuel cell systems.

The air conveyed to the fuel cell 2 after the air conveying means 6 is correspondingly hot and dry. It thus flows firstly through a charging air cooler 13 which is formed as a gas—gas heat exchanger and correspondingly cools the hot feed air through the cool outgoing air from the cathode chamber 3. In addition, the feed air flows through a humidifier 14 that is formed with membranes permeable to water vapor. In the humidifier 14 the now cooled but still dry feed air is then humidified through the membranes permeable to water vapor by the moist outgoing air from the cathode chamber 3. A comparatively cool and moist air thus goes into the cathode chamber 3. The oxygen contained in this air is—at least partially—converted and the membranes 4 are kept correspondingly moist through the moisture in the air so that they cannot dry out. This is very important for the performance of the membranes 4 and their integrity and sealing.

After flowing through the charging air cooler 13, the outgoing air leaves the cathode chamber 3 and then goes into a turbine 15, in which it is expanded, in order to recover a part of the compression energy which was expended during compression of the feed air in the air conveying means 6. The turbine 15 is thereby connected via a shaft 16 with the air conveying means 6. In the region of the shaft 16 an electric machine 17 is also arranged. By means of this machine 17, if necessary, the air conveying means 6 can be correspondingly driven. Power arising at the turbine 15 is used via the shaft 16 also to drive the air conveying means 6. If the air conveying means 6 does not require or only requires a minimum amount of power, in particular less than arising in the region of the turbine 15, the electric machine 17 can also be operated as a generator in order to thus convert power obtained through the turbine 15 into electric power. This electric power can then be used in turn to drive further components and/or stored in an electric energy storage means in order to be used as required again for the electric machine 17 in motor operation or other electrical consumers in the region of the fuel cell system 1.

The structure described thus far is thus known from the prior art. The fuel cell system 1 can be formed, for example, as a stationary fuel cell system 1. It can be used in particular, however, also to drive a transport means, thus any mobile means on water, on land or in air. A preferred use of the fuel cell system 1 lies in particular in use to provide electrical drive energy in a motor vehicle, for example a motor car or a utility vehicle. It is necessary, particularly in this situation, that the fuel cell system also works reliably at temperatures below freezing point and, in particular if it is started at temperatures below freezing point, it facilitates a rapid and reliable start of the fuel cell system 1. It is known for this purpose from the general prior art that the fuel cell system 1 must be brought into a state upon switching off thereof, in which a secure and reliable restart is possible. This applies in particular if it is switched off at temperatures below freezing point or if after the fuel cell system 1 has been switched off, the temperatures may fall before restart of the fuel cell system 1 below freezing point. In this situation liquid water in the region of the fuel cell system 1 that occurs highly purely as product water and thus freezes already at 0° can freeze in pipelines and/or functional components. In particular, the turbine 15 can be blocked by frozen droplets so that a restart of the fuel cell system 1 is not possible or only possible after a tiresome thawing of the turbine 15. This applies particularly when the turbine 15 is connected via the shaft 16 fixedly with the air conveying means 6, as then not only the turbine 15 but also the air conveying means 6 is correspondingly blocked by frozen droplets.

It is thus known from the general prior art to flush the fuel cell system 1 correspondingly in order to drive out and dry moisture for example in a switching-off procedure of the fuel cell system 1. The fuel cell system 1 is thus in a dry state after switching off. This means that no further water vapor is present which could condense and that no liquid water is present which could freeze at critical points of the fuel cell system 1 and could block pipeline elements. This applies in particular to the charging air cooler, the humidifier and the cathode chamber 3 of the fuel cell itself. In principle this also applies to the anode chamber. As the present invention only deals, however, with the cathode side of the fuel cell 2 or the fuel cell system 1, this will not be dealt with in greater detail here.

The flushing of the cathode side of the fuel cell system 1 is now carried out by compressed air from the air conveying means 6. The air is pressed through the charging air cooler 13, the humidifier 14 and the cathode chamber 3 of the fuel cell 2 and then passes via the outgoing air line into the region of the turbine 15 before it is discharged to the environment of the fuel cell system 1. In order to now ensure that all components, in particular the turbine 15 mentioned last in this sequence, remain free of liquid water and water vapor, a comparatively large air mass is necessary so that a correspondingly high energy consumption arises during compression of the required air in the air conveying means 6. In addition, the large air mass dries and the thus resulting volume flow of dry air dries the membranes 4 of the fuel cell 2 very greatly so that such a method is dry as far as the turbine 15, which damages membranes 4 of the fuel cell at least as seen in the long term.

According to the inventive method it is provided that via a valve means 18, a so-called system bypass valve, at least after flushing for a certain time, produces a connection between the air conveying means 6 and the outgoing air before reaching the turbine 15. A path for the air is thereby produced that has a lower pressure loss than the path through the components 13, 14 and 3. A large part of the air will thus pass via the system bypass valve 18 directly from the air conveying means 6 into the region of the turbine 15 and correspondingly dry this. This is possible with comparatively low energy resources and allows the membranes 4 of the fuel cell 2 to be correspondingly spared after it has been dried to a moisture level which is adequate for later restart.

In principle it would of course be conceivable to arrange the system bypass valve 18 not only directly between the outlet of the air conveying means 6 and the inlet of the turbine 15 but to arrange it as a connection of the feed air line for example between the charging air cooler 13 and the humidifier 14 or also between the humidifier 14 and the cathode chamber 3 of the fuel cell 2. This is indicated by the optional system bypass valves 18′ and 18″ in FIG. 1a. In principle it would also be conceivable to arrange not only a system bypass valve 18 but also to provide a dedicated valve means 18, 18′, 18″ at two or all three points. These could then be closed one after the other according to the desired level of dryness of the individual components so that respectively only the component to be dried or the components to be dried must be flowed through via the air conveying means 6. A sparing and energy-efficient process of the flushing process is thus guaranteed.

The primary aim of flushing the fuel cell system 1 or its cathode side with dry air lies directly after the disconnection of the fuel cell system 1 in order to place said fuel cell system 1 in a state in which it can be optimally and very quickly started again. Alternatively or additionally, such a flushing process can also be carried out during the operation of the fuel cell system 1, particularly when the temperature, thus the ambient temperature of the fuel cell system 1, lies below freezing point or when it is so low that it is to be expected to fall below freezing point imminently. Such an occasional flushing can be carried out, similarly to the abovementioned flushing process, for example by opening the system bypass valve 18 and drying out the turbine 15 in order to prevent water freezing in the region of the turbine if this is in slow operation or for example in standby operation during a stop phase of a vehicle equipped with the fuel cell system 1 and a start-stop control. Such freezing can thus be prevented by drying with minimal energy use via the system bypass valve 18, as a blocked turbine 15 typically also blocks the outgoing air and possibly the air conveying means 6 and thus prevents or at least clearly hinders operation of the fuel cell system 1.

The fuel cell 2 itself, the charging air cooler 13 and the humidifier 14 thereby typically lie inside the system and have a comparatively large mass so that freezing is not to be feared here during a short standstill phase. The turbine lies together with the air conveying means, however, frequently outside of the actual fuel cell system, so that here during short standby phases there is the risk of freezing. An exclusive flushing of the turbine via the system bypass valve 18 then generally suffices.

For purposes of flushing during disconnection this can be carried out only at temperatures below freezing point or at very low temperatures that allow it to be expected that the temperatures will fall below freezing point by the time of the restart. Such a diagnosis is very difficult, however, as for example high day temperatures can arise when the vehicle is switched off and greatly deviating night temperatures below freezing point. If the restart does not take place until the next morning freezing of the system can arise. It can thus be provided according to a preferred embodiment of the method according to the invention that the flushing of the system takes place in the final, longer term switching-off in any case.

FIG. 2 illustrates a representation of an alternative fuel cell system 1 that can likewise be used with the inventive method for flushing. Below only the differences in the fuel cell system of FIG. 2 having regard to the fuel cell system 1 in FIG. 1 will be addressed. A first difference lies for example in that the charging air cooler 13 and the humidifier 14 are brought together here in a single structural unit. Such a structural unit is typically also described as an enthalpy exchanger. In addition the discharge line 12 for the outgoing gas from the anode chamber 5 does not run into the feed air to the cathode chamber 3 but instead into a gas line 19 that is connected via a valve means 20 in addition with the hydrogen storage means 7. The gas line 19 then leads into the region of the outgoing air and indeed before a burner 21 which is formed to combust the residual hydrogen in the outgoing gas and/or optional hydrogen fed via the valve means 20. The burner 21 can thereby be designed as a pore burner or in particular as a catalytic burner. It is in a position to increase the temperature in the outgoing air correspondingly in order to increase the efficiency of the turbine 15 and thus reduce the power required by the electric machine 17 to compress the air in the air conveying means 6.

Otherwise the fuel cell system 1 according to the embodiment of FIG. 2 can be operated like the abovementioned fuel cell system. In particular upon switching-off or in suitable operating states flushing can take place in order to correspondingly dry the fuel cell system 1 or the cathode side of the fuel cell system 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A method for operating a fuel cell system with at least one fuel cell and a feed air side air conveying means and an outgoing air side turbine, the method comprising:
flushing the fuel cell system at least during a switching-off procedure with air from the air conveying means; and
creating a connection, during the flushing, between the air conveying means and the outgoing air side between the fuel cell and turbine.

13. The method according to claim 12, wherein the flushing takes place directly after switching off the fuel cell system.

14. The method according to claim 12, wherein the connection between the air conveying means and the outgoing air side is only created when the flushing has already lasted a certain time.

15. The method according to claim 12, wherein the flushing is only carried out when the ambient temperature falls below a predefined value.

16. The method according to claim 12, wherein the flushing additionally takes place occasionally during operation of the fuel cell system.

17. The method according to claim 16, wherein the occasional flushing is triggered in dependence upon the ambient temperature and the operating duration since the last flush.

18. The method according to claim 16, wherein the occasional flushing is triggered in appropriate operating states of the fuel cell system.

19. The method according to claim 12, wherein the air conveying means is driven at least partially by the turbine.

20. The method according to claim 12, wherein an electric machine is in at least indirect connection with the air conveying means and the turbine for motor drive or generator use.

21. The method according to claim 12, wherein the method is used to operate the fuel system in a motor vehicle.

22. The method according to claim 21, wherein the fuel cell system drives the motor vehicle.
